(19) United States
(12) Patent Application Publication
(10) Pub. No.: US 2025/0181902 A1
(43) Pub. Date: Jun. 5, 2025

(54) METHOD AND APPARATUS FOR EVALUATING QUANTIZED ARTIFICIAL NEURAL NETWORK

(71) Applicant: MOBILINT, INC., Seoul (KR)

(72) Inventor: YOUNG ROCK OH, Gyeonggi-do (KR)

(21) Appl. No.: 18/835,785

(22) PCT Filed: Jul. 15, 2024
(86) PCT No.: PCT/KR2024/010111

§ 371 Date: Aug. 5, 2024

(30) Foreign Application Priority Data
Dec. 1, 2023 (KR) 10-2023-0172418

(51) Int. Cl. G06N 3/0495

(52) U.S. Cl. CPC G06N 3/0495

(57) ABSTRACT

In a method for evaluating a quantized artificial neural network according to an embodiment, at least one original feature map for input data is generated using a first artificial neural network model, importance of each element of the at least one original feature map is determined, at least one quantized feature map for the input data is generated using a second artificial neural network model that is a quantized artificial neural network model for the first artificial neural network model, an evaluation value for the second artificial neural network model is calculated based on at least one original feature map, the at least one quantized feature map, and the importance.

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/KR2024/010111, filed Jul. 15, 2024, which claims priority to the benefit of Korean Patent Application No. 10-2023-0172418 filed in the Korean Intellectual Property Office on Dec. 1, 2023, the entire contents of which are incorporated herein by reference.

### BACKGROUND

### 1. Technical Field

Disclosed embodiments relate to an artificial intelligence technology.

### 2. Background Art

Recently, a quantization technology is receiving attention as one of methods for improving power efficiency while reducing a computation amount of an artificial neural network model in the field of artificial intelligence.

Meanwhile, a method of evaluating a quantized model using a validation data set and a method of evaluating a quantized model using the difference (e.g., mean square error (MSE)) between a feature map generated from an original model and a feature map generated from the quantized model have been proposed as methods for evaluating the performance of a quantized model. However, the former requires securing of a separate data set for separate validation and labeling the secured data set, and it is often difficult to secure the data set for validation due to a privacy issue. In the case of the latter, the performance of a quantized model with a smaller MSE is estimated to be better, but the correlation between the MSE and the performance of a quantized model is weak.

### SUMMARY

Disclosed embodiments are for providing a method and apparatus for evaluating a quantized artificial neural network.

A method for evaluating a quantized artificial neural network according to an embodiment comprises: generating at least one original feature map for input data using a first artificial neural network model; determining importance of each element of the at least one original feature map; generating at least one quantized feature map for the input data using a second artificial neural network model that is a quantized artificial neural network model for the first artificial neural network model; and calculating an evaluation value for the second artificial neural network model based on the at least one original feature map, the at least one quantized feature map, and the importance.

The at least one original feature map may include a feature map generated in at least one of a plurality of layers included in the first artificial neural network model, and the at least one quantized feature map may include a quantized feature map generated in layers corresponding to respective layers of the first artificial neural network model, which have generated the at least one original feature map, among a plurality of layers included in the second artificial neural network model.

The method may further comprise: generating at least one piece of modified data for the input data; and generating at least one feature map for each of the at least one piece of modified data using the first artificial neural network model, wherein the determining of the importance may comprise determining the importance of each element of the at least one original feature map based on the at least one original feature map and the at least one feature map for each of the at least one piece of modified data.

The determining of the importance may comprise determining the importance based on a difference between corresponding elements among each element of the at least one original feature map and each element of the at least one feature map for each of the at least one piece of modified data.

The determining of the importance may comprise determining the importance using a metric learning loss function.

The determining of the importance may comprise determining the importance using a gradient of each of the at least one original feature map with respect to an output of the first artificial neural network model for the input data.

The calculating of the evaluation value may comprise calculating the evaluation value based on a distance, considering the importance, between each of the at least one original feature map and a feature map corresponding to each of the at least one original feature map among the at least one quantized feature map.

The calculating of the evaluation value may comprise calculating the evaluation value based on a distance between a result of applying the importance of each element of a feature map generated by an i-th layer of the first artificial neural network model among the at least one original feature map to the feature map generated by the i-th layer of the first artificial neural network model and a result of applying the importance of each element of the feature map generated by the i-th layer of the first artificial neural network model to a feature map generated by an i-th layer of the second artificial neural network model among the at least one quantized feature map.

An apparatus for evaluating a quantized artificial neural network according to an embodiment comprises: one or more processors; and a memory for storing one or more programs executed by the one or more processors, wherein the one or more processors are configured to: generate at least one original feature map for input data using a first artificial neural network model, determine importance of each element of the at least one original feature map, generate at least one quantized feature map for the input data using a second artificial neural network model that is a quantized artificial neural network model for the first artificial neural network model, and calculate an evaluation value for the second artificial neural network model based on the at least one original feature map, the at least one quantized feature map, and the importance.

The at least one original feature map may include a feature map generated in at least one of a plurality of layers included in the first artificial neural network model, and the at least one quantized feature map may include a quantized feature map generated in layers corresponding to respective layers of the first artificial neural network model, which have generated the at least one original feature map, among a plurality of layers included in the second artificial neural network model.

The one or more processors may be further configured to: generate at least one piece of modified data for the input data, generate at least one feature map for each of the at least one piece of modified data using the first artificial neural network model, and determine the importance of each element of the at least one original feature map based on the at least one original feature map and the at least one feature map for each of the at least one piece of modified data.

The one or more processors may be further configured to determine the importance based on a difference between corresponding elements among each element of the at least one original feature map and each element of the at least one feature map for each of the at least one piece of modified data.

The one or more processors may be further configured to determine the importance using a metric learning loss function.

The one or more processors may be further configured to determine the importance using a gradient of each of the at least one original feature map with respect to an output of the first artificial neural network model for the input data.

The one or more processors may be further configured to calculate the evaluation value based on a distance, considering the importance, between each of the at least one original feature map and a feature map corresponding to each of the at least one original feature map among the at least one quantized feature map.

The one or more processors may be further configured to calculate the evaluation value based on a distance between a result of applying the importance of each element of a feature map generated by an i-th layer of the first artificial neural network model among the at least one original feature map to the feature map generated by the i-th layer of the first artificial neural network model and a result of applying the importance of each element of the feature map generated by the i-th layer of the first artificial neural network model to a feature map generated by an i-th layer of the second artificial neural network model among the at least one quantized feature map.

According to disclosed embodiments, it is not required to secure a separate validation data set or label a data set in order to validate a quantized model, and the importance of each element of a feature map generated by an unquantized original model is used to evaluate the performance of the quantized model, and thus the quantized model may be precisely evaluated compared to the prior art.

### BRIEF DESCRIPTION OF THE DRAWINGS

FIG. 1 is a configuration diagram illustrating an evaluation apparatus according to an embodiment;

FIG. 2 is a flowchart illustrating a quantized artificial neural network evaluation method according to an embodiment; and

FIG. 3 is a block diagram exemplarily illustrating a computing environment that includes a computing device according to an embodiment.

### DETAILED DESCRIPTION

Hereinafter, specific embodiments of the present invention will be described with reference to the accompanying drawings. The following detailed description is provided to assist in a comprehensive understanding of the methods, devices and/or systems described herein. However, the detailed description is only illustrative, and the present invention is not limited thereto.

In describing embodiments of the present invention, when a specific description of known technology related to the present invention is deemed to make the gist of the present invention unnecessarily vague, the detailed description thereof will be omitted. The terms used below are defined in consideration of functions in the present invention, but may vary in accordance with the customary practice or the intention of a user or an operator. Therefore, the terms should be defined based on whole content throughout the present specification. The terms used herein are only for describing the embodiments of the present invention, and should not be construed as limitative. A singular expression includes a plural meaning unless clearly used otherwise. In the present description, expressions such as “include” or “have” are for referring to certain characteristics, numbers, steps, operations, components, some or combinations thereof, and should not be construed as excluding the presence or possibility of one or more other characteristics, numbers, steps, operations, components, some or combinations thereof besides those described.

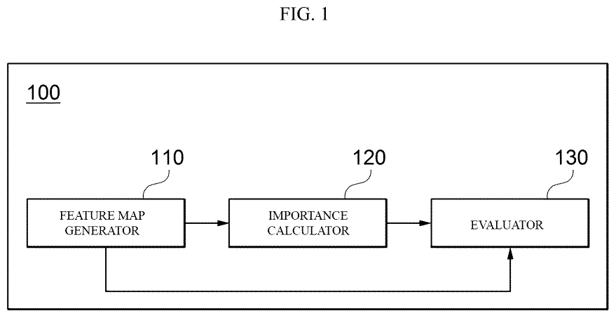

FIG. 1 is a configuration diagram illustrating an evaluation apparatus according to an embodiment.

Referring to FIG. 1, an evaluation apparatus 100 according to an embodiment includes a feature map generator 110, an importance calculator 120, and an evaluator 130.

In an embodiment, the feature map generator 110, the importance calculator 120, and the evaluator 130 may be implemented using one or more physically separated devices or may be implemented using at least one processor or a combination of at least one processor and software, and may not be clearly differentiated from each other in terms of specific operation unlike the illustrated example.

The feature map generator 110 generates at least one original feature map for input data using a first artificial neural network model, and generates at least one quantized feature map for the input data using a second artificial neural network model that is a quantized artificial neural network model for the first artificial neural network model.

According to an embodiment, the input data may be, for example, multidimensional matrix data such as an image.

According to an embodiment, the first artificial neural network model may be, for example, a deep neural network model, such as a convolutional neural network (CNN), including a plurality of layers configured to generates a feature map for input data. However, the first artificial neural network model is not necessarily limited thereto, and may be configured with variously structured artificial neural networks including a plurality of layers configured to generate a feature map for an input image.

Meanwhile, according to an embodiment, the second artificial neural network model may be a model generated by quantizing an output of an activation function and a weight of an artificial neural network constituting the first artificial neural network model. In detail, the second artificial neural network model may be a model generated by converting data formats of the output of the activation function and the weight of the first artificial neural network model into data formats expressed in fewer bits through quantization while maintaining a neural network structure of the first artificial neural network model.

For example, if the weight of the first artificial neural network model and the output of the activation function have a fixed point data format expressed in 32 bits, the second artificial neural network model may be a model generated by converting the weight of the first artificial neural network model and the output of the activation function into a fixed point data format expressed in 16 bits or an integer data format expressed in 8 bits using a preset mapping function. However, the data formats of the first artificial neural network model and the second artificial neural network model and a quantization scheme used for generating the second artificial neural network model are not necessarily limited to particular examples.

According to an embodiment, the at least one original feature map for input data may include a feature map generated in at least one of the plurality of layers included in the first artificial neural network model. Furthermore, the at least one quantized feature map for input data may include feature maps generated in layers corresponding to respective layers of the first artificial neural network model, which have generated the at least one original feature map for input data, among the plurality of layers included in the second artificial neural network model. In detail, the at least one original feature map for input data may include a feature map generated in an i-th layer (where i is a positive integer satisfying 1≤i≤n, where n denotes the number of layers included in the first artificial neural network model), and the at least one quantized feature map for input data may include a feature map generated in an i-th layer of the second artificial neural network model.

Meanwhile, according to an embodiment, the feature map generator 110 may generate at least one piece of modified data for input data, and may generate at least one feature map for each of the at least one piece of modified data using the first artificial neural network model. Here, the modified data may be generated by adding, for example, a perturbation such as random noise to the input data. Furthermore, the at least one feature map for the modified data may include a feature map generated for the modified data in each of layers that have generated the at least one original feature map for input data among the plurality of layers of the first artificial neural network model.

The importance calculator 120 determines importance of each element of the at least one original feature map for input data.

Here, the importance of each element of the original feature map may represent sensitivity of each element to a change in the input data. For example, the importance calculator 120 may determine the importance of each element of the original feature map so that elements which change relatively significantly with respect to a change in the input data have higher importance and elements which change relatively little with respect to a change in the input data have lower importance.

According to an embodiment, the importance calculator 120 may determine the importance of each element of the at least one original feature map for input data on the basis of the at least one original feature map for input data and the at least one feature map for each of the at least one piece of modified data. In detail, the importance calculator 120 may determine the importance of each element of the at least one original feature map on the basis of a difference between corresponding elements among each element of the at least one original feature map for input data and each element of the at least one feature map for each of the at least one piece of modified data.

For example, a difference between each element of a feature map generated in an i-th layer of the first artificial neural network model among the at least one original feature map for input data and each element of a feature map generated in the i-th layer of the first artificial neural network model for a j-th piece of modified data among the at least one piece of modified data may be calculated according to Equation 1 below.

$${D}_{j}^{( i )} ( x ) = {d}_{1} ( {F}^{( i )} ( x ) , {F}^{( i )} ( x + {ε}_{j} ) ) \qquad [ Equation 1 ]$$

In Equation 1, x denotes input data, εⱼ denotes a perturbation added to the input data x to generate a j-th piece of modified data, F⁽ⁱ⁾(x) denotes a feature map generated by the i-th layer of the first artificial neural network model for the input data, and F⁽ⁱ⁾(x+εⱼ) denotes a feature map generated by the i-th layer of the first artificial neural network model for the j-th piece of modified data. Furthermore, d₁ denotes a function for calculating a difference between corresponding elements among each element of F⁽ⁱ⁾(x) and each element of F⁽ⁱ⁾(x+εⱼ), and Dⱼ⁽ⁱ⁾(x) denotes a difference matrix including difference values between corresponding elements among each element of F⁽ⁱ⁾(x) and each element of F⁽ⁱ⁾(x+εⱼ). In detail, F⁽ⁱ⁾(x), F⁽ⁱ⁾(x+εⱼ), and Dⱼ⁽ⁱ⁾(x) are multidimensional matrices of the same size, and each element of Dⱼ⁽ⁱ⁾(x) indicates a difference between corresponding elements in F⁽ⁱ⁾(x) and F⁽ⁱ⁾(x+εⱼ). For example, if F⁽ⁱ⁾(x), F⁽ⁱ⁾(x+εⱼ), and Dⱼ⁽ⁱ⁾(x) are two-dimensional matrices of the same size, a first element of a first row of Dⱼ⁽ⁱ⁾(x) may indicate a difference between a first element of a first row of F⁽ⁱ⁾(x) and a first element of a first row of F⁽ⁱ⁾(x+εⱼ).

Meanwhile, the importance of each element of the feature map F⁽ⁱ⁾(x) generated by the i-th layer of the first artificial neural network model among the at least one original feature map for input data may be calculated according to, for example, Equation 2 below.

$${I}^{( i )} ( x ) = S ( {\{ {D}_{j}^{( i )} \}}_{j = 1}^{m} ) \qquad [ Equation 2 ]$$

In Equation 2, m denotes the number of pieces of modified data, S denotes a function for calculating the importance of each element of F⁽ⁱ⁾(x) using corresponding elements of each difference matrix Dⱼ⁽ⁱ⁾(x), and I⁽ⁱ⁾ denotes an importance matrix including an importance value of each element of F⁽ⁱ⁾(x). Here, S may be, for example, a function for calculating p-norm, sample variance, and the like for corresponding elements of each difference matrix.

In detail, Dⱼ⁽ⁱ⁾(x), F⁽ⁱ⁾(x), and I⁽ⁱ⁾ may be multidimensional matrices of the same size. Furthermore, each element of I⁽ⁱ⁾ may indicate the importance of a corresponding element of F⁽ⁱ⁾(x), and may be calculated through p-norm or sample variance for corresponding elements of each difference matrix Dⱼ⁽ⁱ⁾(x). For example, if Dⱼ⁽ⁱ⁾(x), F⁽ⁱ⁾(x), and I⁽ⁱ⁾ are two-dimensional matrices of the same size, a first element of a first row of I⁽ⁱ⁾ may indicate the importance of a first element of a first row of F⁽ⁱ⁾(x), and may be calculated through p-norm or sample variance for first elements of a first row of each difference matrix Dⱼ⁽ⁱ⁾(x).

Meanwhile, according to another embodiment, the importance calculator 120 may determine the importance of each element of the at least one original feature map for input data using a metric learning loss function. Here, the metric learning loss function may be, for example, contrastive loss, triplet loss, margin loss, N-pair loss, etc.

As a specific example, when the metric learning loss function is a contrastive loss function, the importance of each element of the feature map F⁽ⁱ⁾(x) generated by the i-th layer of the first artificial neural network model among the at least one original feature map for input data may be calculated according to Equation 3 or Equation 4 below.

$${I}^{( i )} ( x ) = {l}_{metric} ( {F}^{( i )} ( x ) , {F}^{( i )} ( {x}^{-} ) ) \qquad [ Equation 3 ]$$

$${I}^{( i )} ( x ) = {l}_{metric} ( {F}^{( i )} ( x ) , {F}^{( i )} ( {x}^{+} ) ) \qquad [ Equation 4 ]$$

For another example, when the metric learning loss function is a triplet loss function, the importance of each element of the feature map F⁽ⁱ⁾(x) may be calculated according to Equation 5 below.

$${I}^{( i )} ( x ) = {l}_{metric} ( {F}^{( i )} ( x ) , {F}^{( i )} ( {x}^{-} ) , {F}^{( i )} ( {x}^{+} ) ) \qquad [ Equation 5 ]$$

In addition, for another example, when the metric learning loss function is an N-pair loss function, the importance of each element of the feature map F⁽ⁱ⁾(x) may be calculated according to Equation 6 below.

$${I}^{( i )} ( x ) = {l}_{metric} ( {F}^{( i )} ( x ) , {F}^{( i )} ( {x}^{+} ) , {F}^{( i )} ( {x}_{1}^{-} ) , {F}^{( i )} ( {x}_{N - 1}^{-} ) ) \qquad [ Equation 6 ]$$

Meanwhile, in Equations 3 to 6, l_{metric} denotes the metric learning loss function. Furthermore, x⁻ denotes a negative sample generated from x, and x⁺ denotes a positive sample generated from x. Here, the negative sample may represent a sample having a relatively large difference from x compared to the positive sample, and the positive sample may represent a sample having a relatively small difference from x compared to the negative sample.

According to another embodiment, the importance calculator 120 may determine the importance of each element of the at least one original feature map for input data using a gradient of each of the at least one original feature map for input data. For example, the importance of each element of the feature map F⁽ⁱ⁾(x) generated by the i-th layer of the first artificial neural network model among the at least one original feature map for input data may be calculated according to Equation 7 below.

$${I}^{( i )} ( x ) = \frac{\partial O ( {F}^{( i )} ( x ) )}{\partial {F}^{( i )} ( x )} \qquad [ Equation 7 ]$$

In Equation 7, O(x) denotes a target output of the first artificial neural network model for input data or a difference between an output and the target output of the first artificial neural network model for input data.

The evaluator 130 calculates an evaluation value for the second artificial neural network model on the basis of the at least one original feature map for input data, the at least one quantized feature map for input data, and the importance of each element of the at least one original feature map for input data.

According to an embodiment the evaluator 130 may calculate the evaluation value for the second artificial neural network model on the basis of a distance, considering the importance of each element of each original feature map for input data, between each original feature map and the quantized feature map corresponding to each original feature map. In detail, the evaluator 130 may calculate the evaluation value for the second artificial neural network model on the basis of a distance between a result of applying the importance of each element of the feature map generated by the i-th layer of the first artificial neural network model among the at least one original feature map to the feature map generated by the i-th layer of the first artificial neural network model and a result of applying the importance of each element of the feature map generated by the i-th layer of the first artificial neural network model to the feature map generated by the i-th layer of the second artificial neural network model among the at least one quantized feature map.

For example, a distance Ψᵢ between the feature map F⁽ⁱ⁾(x) generated by the i-th layer of the first artificial neural network model among the at least one original feature map for input data and the feature map \hat{F}⁽ⁱ⁾(x) generated by the i-th layer of the second artificial neural network model among the at least one quantized feature map for input data may be calculated using Equation 8 below.

$${Ψ}_{i} = {d}_{2} ( ϕ ( {I}^{( i )} ( x ) ) ⊙ {F}^{( i )} ( x ) , ϕ ( {I}^{( i )} ( x ) ) ⊙ {\hat{F}}^{( i )} ( x ) ) \qquad [ Equation 8 ]$$

In Equation 8, ⊙ denotes an elementwise product between matrices, and φ denotes a normalization function that normalizes a value of each element in a matrix while maintaining a size order of each element, such as a min-max normalization function, a softmax function, or the like. Furthermore, d₂ may be a distance function for measuring a distance between two matrices, such as matrix norm.

Meanwhile, according to an embodiment, the evaluator 130 may calculate the evaluation value for the second artificial neural network model by applying an aggregation function to a distance between the at least one original feature map and the quantized feature map corresponding to each of the at least one original feature map. Here, for example, average, weighted sum, weighted average, or the like may be used in the aggregation function.

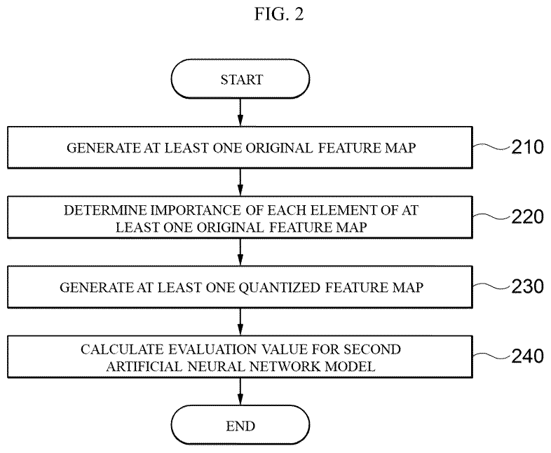

FIG. 2 is a flowchart illustrating a quantized artificial neural network evaluation method according to an embodiment.

The method illustrated in FIG. 2 may be performed by, for example, the evaluation apparatus 100.

Referring to FIG. 2, the evaluation apparatus 100 generates at least one original feature map for input data using the first artificial neural network model (210).

Thereafter, the evaluation apparatus 100 determines the importance of each element of the at least one original feature map (220).

Here, according to an embodiment, the evaluation apparatus 100 may generate at least one feature map for each of at least one piece of modified data for input data using the first artificial neural network model, and may determine the importance of each element of the at least one original feature map on the basis of the at least one original feature map and the at least one feature map for each of the at least one piece of modified data.

According to another embodiment, the evaluation apparatus 100 may determine the importance of each element of the at least one original feature map using a metric learning loss function.

According to another embodiment, the evaluation apparatus 100 may determine the importance of each element of the at least one original feature map using a gradient of each of the at least one original feature map.

Thereafter, the evaluation apparatus 100 generates at least one quantized feature map for input data using the second artificial neural network model (230).

Here, according to an embodiment, the at least one quantized feature map may include feature maps generated in layers corresponding to respective layers of the first artificial neural network model, which have generated the at least one original feature map, among the plurality of layers included in the second artificial neural network model.

Thereafter, the evaluation apparatus 100 calculates an evaluation value for the second artificial neural network model on the basis of the at least one original feature map, the at least one quantized feature map, and the importance of each element of the at least one original feature map (240).

Here, according to an embodiment, the evaluation apparatus 100 may calculate the evaluation value for the second artificial neural network model on the basis of a distance, considering the importance of each element of each original feature map for input data, between each original feature map and the quantized feature map corresponding to each original feature map.

In the flowchart illustrated in FIG. 2, at least some of the operations may be performed by changing the order of the operations, may be performed in combination with other operations, may be skipped, may be divided into detailed operations, or may be performed by adding at least one operation which is not shown.

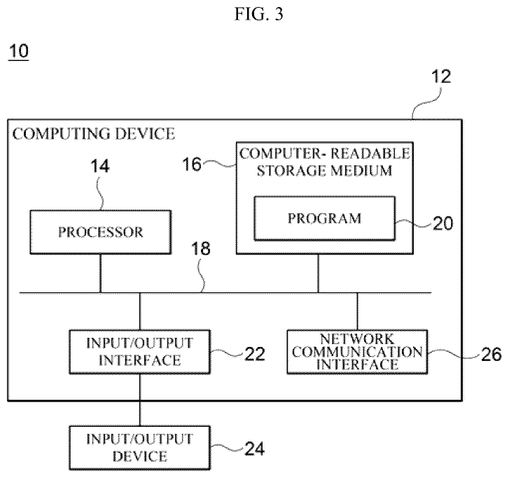

FIG. 3 is a block diagram exemplarily illustrating a computing environment that includes a computing device according to an embodiment. In the illustrated embodiment, each component may have different functions and capabilities in addition to those described below, and additional components may be included in addition to those described below.

The illustrated computing environment 10 includes a computing device 12. The computing device 12 may be one or more components included in the evaluation apparatus 100 according to an embodiment.

The computing device 12 includes at least one processor 14, a computer-readable storage medium 16, and a communication bus 18. The processor 14 may cause the computing device 12 to operate according to the above-described example embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the example embodiments. Meanwhile, according to an embodiment, the at least one processor 14 may include at least one of a central processing unit (CPU), a graphics processing unit (GPU), or a neural processing unit, but is not necessarily limited thereto.

The computer-readable storage medium 16 is configured to store computer-executable instructions or program codes, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random access memory, a non-volatile memory, or any suitable combination thereof), one or more magnetic disk storage devices, optical disk storage devices, flash memory devices, other types of storage media that are accessible by the computing device 12 and store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The example input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, a speaker, and/or a network card. The example input/output device 24 may be included inside the computing device 12 as a component constituting the computing device 12, or may be connected to the computing device 12 as a separate device distinct from the computing device 12.

An embodiment of the present invention may include a program for executing the methods described herein on a computer and a computer-readable recording medium including the program. The computer-readable recording medium may include a program command, a local data file, and a local data structure, taken alone or in combination. The above medium may be specially designed for the present invention or may be commonly available in the technical field of computer software. Examples of the computer-readable recording medium include hardware devices specially configured to store and perform program commands, such as magnetic media such as hard disks, floppy disks, and magnetic tapes, optical media such as CD-ROMs and DVDs, ROMs, RAMs, and flash memories. Examples of the program may include not only machine codes such as those produced by a compiler but also high-level language codes that may be executed by a computer using an interpreter.

Although the representative embodiments of the present invention have been described in detail as above, those skilled in the art will understand that various modifications may be made thereto without departing from the scope of the present invention. Therefore, the scope of rights of the present invention should not be limited to the described embodiments, but should be defined not only by the claims set forth below but also by equivalents of the claims.

1: A method for evaluating a quantized artificial neural network, performed by a computing device having one or more processors and a memory for storing one or more programs executed by the one or more processors, the method comprising:
generating at least one original feature map for input data using a first artificial neural network model;
determining importance of each element of the at least one original feature map;
generating at least one quantized feature map for the input data using a second artificial neural network model that is a quantized artificial neural network model for the first artificial neural network model; and
calculating an evaluation value for the second artificial neural network model based on the at least one original feature map, the at least one quantized feature map, and the importance,
wherein the calculating of the evaluation value comprises calculating the evaluation value based on a distance, considering the importance, between each of the at least one original feature map and a feature map corresponding to each of the at least one original feature map among the at least one quantized feature map.

2: The method of claim 1,
wherein the at least one original feature map includes a feature map generated in at least one of a plurality of layers included in the first artificial neural network model, and
the at least one quantized feature map includes a quantized feature map generated in layers corresponding to respective layers of the first artificial neural network model, which have generated the at least one original feature map, among a plurality of layers included in the second artificial neural network model.

3: The method of claim 1, further comprising:
generating at least one piece of modified data for the input data; and
generating at least one feature map for each of the at least one piece of modified data using the first artificial neural network model,
wherein the determining of the importance comprises determining the importance of each element of the at least one original feature map based on the at least one original feature map and the at least one feature map for each of the at least one piece of modified data.

4: The method of claim 3, wherein the determining of the importance comprises determining the importance based on a difference between corresponding elements among each element of the at least one original feature map and each element of the at least one feature map for each of the at least one piece of modified data.

5: The method of claim 1, wherein the determining of the importance comprises determining the importance using a metric learning loss function.

6: The method of claim 1, wherein the determining of the importance comprises determining the importance using a gradient of each of the at least one original feature map.

7. (canceled)

8: The method of claim 1, wherein the calculating of the evaluation value comprises calculating the evaluation value based on a distance between a result of applying the importance of each element of a feature map generated by an i-th layer of the first artificial neural network model among the at least one original feature map to the feature map generated by the i-th layer of the first artificial neural network model and a result of applying the importance of each element of the feature map generated by the i-th layer of the first artificial neural network model to a feature map generated by an i-th layer of the second artificial neural network model among the at least one quantized feature map.

9: An apparatus for evaluating a quantized artificial neural network, the apparatus comprising:
one or more processors; and
a memory for storing one or more programs executed by the one or more processors,
wherein the one or more processors are configured to:
generate at least one original feature map for input data using a first artificial neural network model,
determine importance of each element of the at least one original feature map,
generate at least one quantized feature map for the input data using a second artificial neural network model that is a quantized artificial neural network model for the first artificial neural network model, and
calculate an evaluation value for the second artificial neural network model based on the at least one original feature map, the at least one quantized feature map, and the importance,
wherein the one or more processors are further configured to calculate the evaluation value based on a distance, considering the importance, between each of the at least one original feature map and a feature map corresponding to each of the at least one original feature map among the at least one quantized feature map.

10: The apparatus of claim 9,
wherein the at least one original feature map includes a feature map generated in at least one of a plurality of layers included in the first artificial neural network model, and
the at least one quantized feature map includes a quantized feature map generated in layers corresponding to respective layers of the first artificial neural network model, which have generated the at least one original feature map, among a plurality of layers included in the second artificial neural network model.

11: The apparatus of claim 9, wherein the one or more processors are further configured to:
generate at least one piece of modified data for the input data,
generate at least one feature map for each of the at least one piece of modified data using the first artificial neural network model, and
determine the importance of each element of the at least one original feature map based on the at least one original feature map and the at least one feature map for each of the at least one piece of modified data.

12: The apparatus of claim 11, wherein the one or more processors are further configured to determine the importance based on a difference between corresponding elements among each element of the at least one original feature map and each element of the at least one feature map for each of the at least one piece of modified data.

13: The apparatus of claim 9, wherein the one or more processors are further configured to determine the importance using a metric learning loss function.

14: The apparatus of claim 9, wherein the one or more processors are further configured to determine the importance using a gradient of each of the at least one original feature map.

15. (canceled)

16: The apparatus of claim 9, wherein the one or more processors are further configured to calculate the evaluation value based on a distance between a result of applying the importance of each element of a feature map generated by an i-th layer of the first artificial neural network model among the at least one original feature map to the feature map generated by the i-th layer of the first artificial neural network model and a result of applying the importance of each element of the feature map generated by the i-th layer of the first artificial neural network model to a feature map generated by an i-th layer of the second artificial neural network model among the at least one quantized feature map.
